(19) United States
(12) Patent Application Publication
(10) Pub. No.: US 2025/0256324 A1
(43) Pub. Date: Aug. 14, 2025

(54) Apparatus for Processing a Workpiece and Corresponding Method

(71) Applicant: PROFIL Verbindungstechnik GmbH & Co. KG, Friedrichsdorf (DE)

(72) Inventors: Tobias Jene, Friedrichsdorf (DE); Amer Mahlme, Wölfersheim (DE); Andreas LeBeau, Friedrichsdorf (DE)

(21) Appl. No.: 19/053,515

(22) Filed: Feb. 14, 2025

(30) Foreign Application Priority Data
Feb. 14, 2024 (DE) 102024104167.6

(51) Int. Cl. B21J 15/32

(52) U.S. Cl. CPC B21J 15/32

(57) ABSTRACT

The present invention relates to an apparatus for processing a workpiece, said apparatus comprising at least one pressing device having a first tool half and a second tool half that can be moved towards one another in a pressing movement, in particular for reshaping and/or for press hardening the workpiece, and at least one setting device for fastening at least one functional element in a setting movement at a setting point to the workpiece, wherein the setting device is arranged at the first tool half or the second tool half. The first and/or the second tool half has/have a conditioning device with which the first tool half and/or the second tool half can be thermally influenced, in particular selectively thermally influenced.

The invention relates to an apparatus for processing a workpiece and to a corresponding method.

In many manufacturing processes, for example in automotive engineering, workpiece blanks or semi-finished products, in particular metallic sheet metal parts, are formed into the desired shape using reshaping processes. They are often also provided with functional elements as part of such processes.

Such elements, for example, serve to fasten an object to the workpiece. This is often not directly possible without further ado, in particular if the fastening is to be releasable or if a bonded fastening method is unsuitable. The problem frequently occurs with flat or comparatively thin workpieces, such as sheet metal parts, since they cannot be easily provided with a hole having a loadable internal thread. The solution to this problem is, inter alia, nut or bolt elements that are introduced into the sheet metal part and that have the necessary thread or other functional sections for fastening the object. These elements can be introduced into pre-punched holes or can be self-punching.

The fastening of the elements to the workpiece can be a major challenge, in particular if particularly solid materials are involved, e.g. press-hardened materials, or if the geometric conditions are complex.

It is an object of the present invention to provide an apparatus for processing a workpiece, with which apparatus workpieces having challenging properties can also be easily processed, in particular reshaped and reliably fitted with functional elements.

This object is satisfied by an apparatus having the features of claim 1.

According to the invention, the apparatus for processing a workpiece comprises at least one pressing device having a first tool half and a second tool half that can be moved towards one another in a pressing movement, in particular for reshaping (preferably hot shaping) and/or for press hardening the workpiece. Furthermore, at least one setting device for fastening at least one functional element in a setting movement at a setting point to the workpiece is provided. To optimize the setting or joining of the elements, the first and/or the second tool half can have a conditioning device with which the first tool half and/or the second tool half can be thermally influenced, in particular selectively thermally influenced. Since the material of the workpiece can be cooled and/or heated accordingly via the tool halves, a temperature window suitable for the setting process can always be set locally.

The target temperature can therefore be selected as required. For example, it can mean that room temperature is (locally) aimed at by the thermal conditioning and that higher or lower temperatures are present in regions that are no longer thermally dominated by the effect of the thermal conditioning.

It is generally possible for the apparatus to comprise two or more pressing devices and/or setting devices.

Conventionally, workpieces are first reshaped and/or hardened in appropriate presses. They are then fed to a setting device by means of which the functional elements are fastened to the workpieces. After hot shaping processes and in particular after a press hardening, a setting or joining of mechanical functional elements is often only possible with considerable effort due to the hardness of the workpiece produced. Due to the conditioning device provided according to the invention, which is in particular provided in addition to a possibly present heating or cooling device of a workpiece processing apparatus that is e.g. adapted for a hot shaping, the workpiece can be kept locally in a defined temperature window in order to simplify the setting of the elements or even make it possible in the first place.

The processing can take place at room temperature, for example if the processing is a standard cold shaping process. During a hot shaping and/or press hardening, processing temperatures of more than 900° C. can be reached, in particular temperatures in a range from 450° C. to 850° C.

These specifications apply both to the sought-after temperature of the workpiece during processing and to the temperature of the tool halves.

Due to the apparatus according to the invention, the processes “pressing” or “reshaping”, on the one hand, and “setting the element,” on the other hand, can thus be performed in a single apparatus. This eliminates a laborious work step, namely the removal of the workpiece from the pressing device and the exact positioning of the reshaped workpiece in the setting device.

An exemplary field of application of the apparatus is the joining of mechanical functional elements in a press-hardenable, usually boron-alloyed, steel such as 22MnB5 or 34MnB5 with or without an AlSi coating.

The apparatus can generally be used to process any desired workpieces. However, it is preferably intended for processing metallic workpieces, in particular for processing sheet metal parts.

Any desired elements can be considered as functional elements to be set, for example nut and/or bolt elements. They can be provided with threaded sections or have functional sections with other properties. For example, such functional sections are provided with latching elements or with certain shaping elements, such as grooves or ribs. The elements are preferably metallic.

The functional elements can be self-punching. However, the workpiece can also already be pre-punched so that the functional elements are inserted into already existing openings.

The functional elements can be rivet elements comprising a rivet section that is reshaped for fixing the elements to the workpiece in order to form an undercut. However, they can also be press-in elements that are pressed into the workpiece and fixed thereto in a force-fitting manner.

The term “tool half” is to be interpreted broadly. The tool halves can be designed in multiple parts. For example, they comprise a base body, which can also be integrated into a tool assembly, and an exchangeable molding jaw that is assembled for the respective application. It is also conceivable that one of the tool halves comprises a die (replaceable as required) that cooperates with the setting device arranged at the other tool half during operation of the apparatus.

In particular, both tool halves are moved during the pressing movement. However, it is also conceivable that only one of the tool halves is movably arranged and that the other tool half is arranged in a stationary manner. The term “movable towards one another” is thus to be understood as meaning that a relative movement of the two tool halves should be realizable, by which movement the workpiece is reshaped.

Further embodiments of the invention are set forth in the description, in the drawings, and in the claims.

In particular, the conditioning device is configured and set up such that the first and/or the second tool half can be selectively thermally influenced at and/or in a region adjacent to the setting point.

The conditioning device can be configured and set up such that a desired temperature profile can be produced in the first and/or the second tool half. For example, starting from the setting point, a 2D temperature profile can be produced so that optimal setting conditions prevail at the setting point and/or in an adjacent region, whereas other regions of the workpiece are exposed to different temperatures. Provision can be made that certain regions are heated or cooled to different degrees. It is also possible to supply heat to certain regions while other regions are cooled.

According to a further embodiment, the setting device has a conditioning device with which the setting device and/or the workpiece and/or the functional element can be thermally influenced, in particular selectively influenced. Such an additional or alternative conditioning device makes it possible to influence the setting conditions to be able to adjust them as required. Due to the contact of the setting device with the workpiece and/or with the functional element, the conditioning device of the setting device can, if suitably arranged and designed, act not only on the setting device itself but in particular also on the workpiece and/or the functional element.

The following statements apply both to the conditioning device of the tool halves and to that of the setting device.

The conditioning device can comprise a heating device and/or a cooling device. It can be operated electrically (e.g. heating wires) and/or with a fluid (e.g. passages which can be flowed through by a gas or a heating or cooling liquid). Liquid nitrogen or similar can even be considered for a cooling.

In particular, the conditioning device is configured and set up such that the thermal influence is variable in time and/or in space. For this purpose, a suitable control device can be provided with which the conditioning device can be selectively controlled, wherein the control device is preferably connected to a control unit of the apparatus or is integrated into it.

According to one embodiment, the setting device comprises at least one sensor device with which a setting force acting on the functional element and/or at least one characteristic parameter of the setting movement can be detected. Due to one or more sensors integrated in a setting head, a documentation e.g. of the joining force and/or the joining path for assessing the quality of the mechanical functional element connection produced during the (hot) shaping and/or press hardening is possible.

Similarly, the first and/or the second tool half can comprise at least one sensor device with which a pressing force acting between the tool halves and/or a characteristic parameter of the pressing movement and/or a characteristic parameter of the first and/or the second tool half can be detected. A characteristic parameter of the pressing movement can be an amount of the distance traveled, its speed and/or its acceleration; a characteristic parameter of the tool halves can be their temperature, for example.

The characteristic parameter is preferably recorded as a function of time.

The sensor device can be associated with a control device that is preferably connected to a control unit of the apparatus or integrated into it.

The setting device can be arranged at the first tool half or the second tool half and can be operable independently of the pressing device.

By decoupling the operation of the pressing device and the setting device, the pressing movement and the setting movement can be coordinated with one another as required. For example, a setting movement can be initiated if the (possibly already—partly—reshaped) workpiece is in a certain state that is particularly suitable for setting or joining the elements. For example, the setting or joining times can be set while considering the component material and/or the component thickness as well as the sought-after mechanical connection properties. The apparatus is thereby more flexibly usable and better joining results are achieved.

According to one embodiment, the pressing device has a drive device by which the first and the second tool half can be moved towards one another in a linear pressing movement. Alternatively or additionally, the setting device has a setting drive by which the functional element can be pressed against the workpiece in a linear setting movement.

According to a further embodiment, the pressing device and/or the setting device is/are designed such that the pressing movement and the setting movement are not parallel. A joining of the functional elements at an angle that deviates from the pressing movement (e.g. press travel direction or tool closing direction) is thereby possible. For example, an element can be fastened to a section of the workpiece that is arranged obliquely to the direction of the reshaping movement.

The pressing device and/or the setting device can be electrically, hydraulically and/or pneumatically operable. In particular, the pressing device and the setting device can have different types of drives.

The pressing device and the setting device are preferably controlled by a common or higher-ranking control unit.

The tool half at which the setting device is arranged can have an opening into which the setting device projects. The element can thus be fastened to the workpiece “through” the corresponding tool half.

According to one embodiment of the apparatus, it is configured and set up such that a self-punching functional element can be fastened to the workpiece. For this purpose, the tool half disposed opposite the setting device can have an opening through which a punched slug can be discharged. Alternatively or additionally, it can be provided that the setting device has an ejection apparatus for expelling a slug from the functional element. Such an ejection apparatus can, for example, be a die that is axially movable in the direction of the setting movement.

The present invention further relates to a method of processing a workpiece, in particular wherein an apparatus according to any one of the above-described embodiments is used. In this respect, a first tool half and a second tool half of a pressing device of the workpiece are moved towards one another in a pressing movement (in particular for reshaping, preferably for hot shaping and/or press hardening) and a functional element is pressed against the workpiece at a setting point by means of a setting device in a setting movement in order to fasten said functional element to said workpiece. The first and/or the second tool half is/are thermally influenced, in particular selectively thermally influenced, by means of a conditioning device. Alternatively or additionally, the setting device and/or the workpiece and/or the functional element is/are thermally influenced, in particular selectively influenced, by means of a conditioning device associated with the setting device.

The thermal influence in particular only takes place after the pressing process, reshaping process and/or press hardening process has been completed or immediately thereafter. However, it is also conceivable to aim for a (local) thermal influence already during the aforementioned processes in order to optimize the conditions for setting the element. This measure can serve to speed up the processing process and/or can ensure that the material of the workpiece does not locally exceed or fall below locally determined temperature thresholds. In other applications, a pause can also be provided between the respective process and the thermal influence.

To optimize the setting process, the thermal influence can be varied in space and/or in time according to one embodiment of the method.

By means of an optional sensor device, a setting force acting on the functional element and/or at least one characteristic parameter of the setting movement can be detected to be able to monitor and document the creation of the mechanical connection between the element and the workpiece.

In a similar way, by means of an optional sensor device, a pressing force acting between the tool halves and/or a characteristic parameter of the pressing movement and/or a characteristic parameter of the first and/or the second tool half can be detected in order to better monitor the pressing process, reshaping process, press hardening process and/or setting process.

According to one embodiment, the pressing device and the setting device can be operated independently of one another. They are in particular operated such that the setting movement starts after the pressing movement has come to an end. For example, the setting movement can start immediately after the completion of the pressing movement. However, it is also possible to provide a time interval between the two movements, e.g. to wait until the workpiece is in a thermal state that is suitable for setting or joining the element.

Alternatively, the pressing device and the setting device can be operated such that the setting movement starts after a start and before an end of the pressing movement.

According to one embodiment of the method, the pressing device and the setting device are configured and set up such that the setting movement and the pressing movement do not take place in parallel.

The present invention will be explained in the following purely by way of example with reference to an advantageous embodiment and to the enclosed drawings. There are shown:

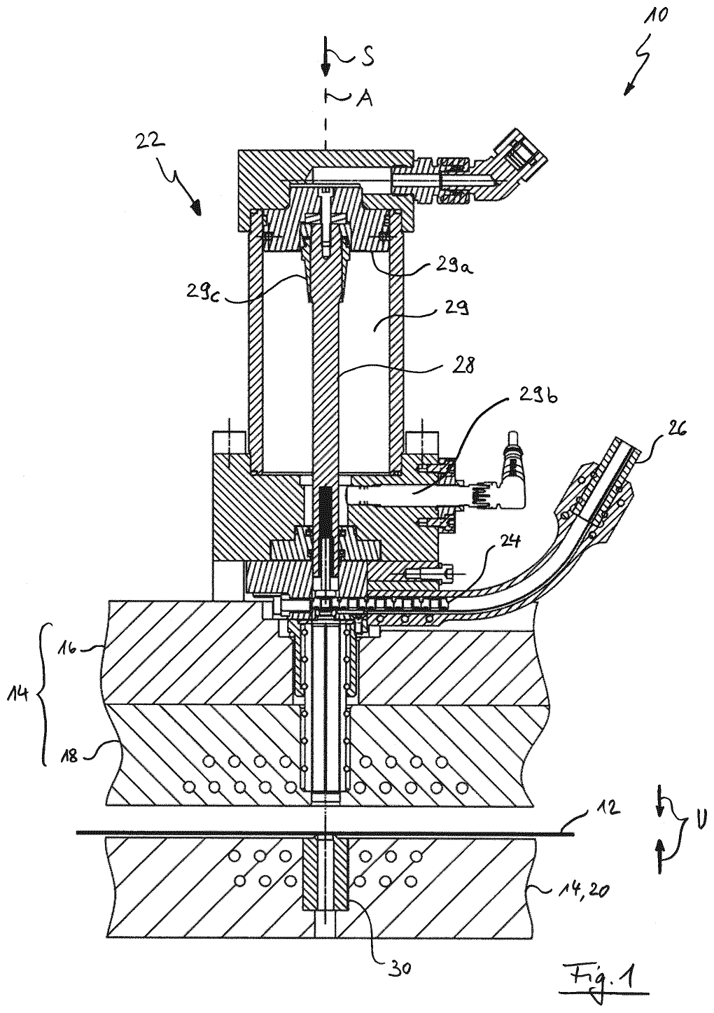

FIGS. 1 to 3 an embodiment of the apparatus according to the invention in different states; and

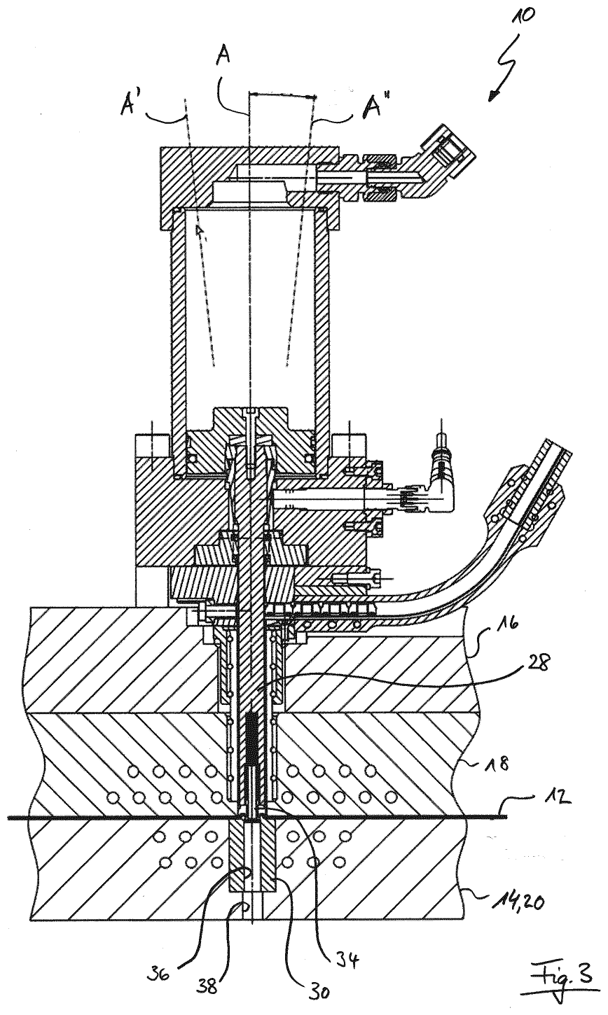

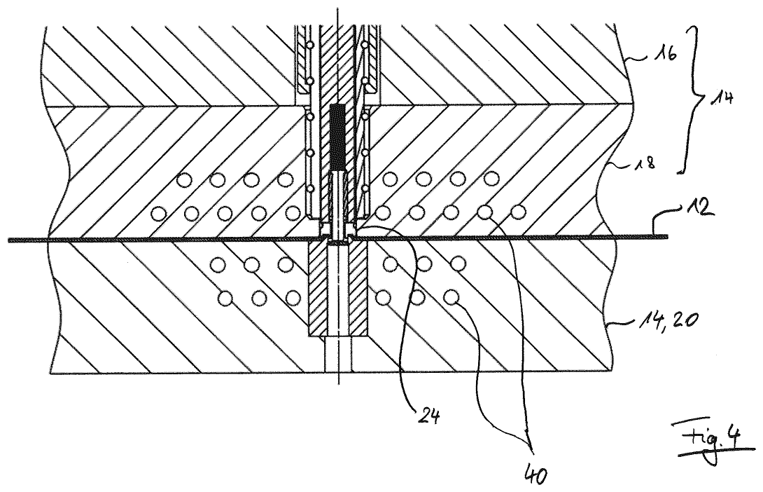

FIG. 4 a section of FIG. 3.

FIG. 1 shows an apparatus 10 for processing a workpiece 12 that is a planar sheet metal part in the base state in the present example. The apparatus 10 comprises a first tool half 14 comprising a base body 16 and a molding jaw 18. The base body 16 can be fastened to a tool structure, not shown, or can be an integral component of a tool structure, for example a C-frame. Furthermore, a second tool half 14 is provided, wherein only its molding jaw 20 is shown in FIG. 1 for reasons of clarity.

In the present example, the workpiece 12 is to be deformed locally and a functional element 24 is to be attached at a setting point in the deformed region. The apparatus 10 can also be adapted to perform press hardening processes or mold hardening processes.

In contrast to what is shown, the molding jaws 18, 20 can have non-planar surfaces shaped in a complementary manner to be able to give the workpiece 12 a certain shape. A reshaping of the workpiece 12 takes place by bringing the molding jaws 18, 20 closer together in a reshaping movement, wherein they are moved towards one another. The direction of the movement of the jaws 18, 20 is indicated by arrows U. It can also be provided that only one of the jaws 18, 20 is moved and that the other jaw 20 or 18 is arranged in a stationary manner.

The apparatus 10 further comprises a setting device 22 of a basically known design. In the present example, it is hydraulically actuable. However, other types of drives are also conceivable. Functional elements 24 can be fed to the setting device 22 by means of a hose 26.

The end of the setting device 22 facing the workpiece 12 projects through openings in the base body 16 and the molding jaw 18 so that the provided functional elements 24 can be brought towards the workpiece by means of a setting die 28 in a setting movement S.

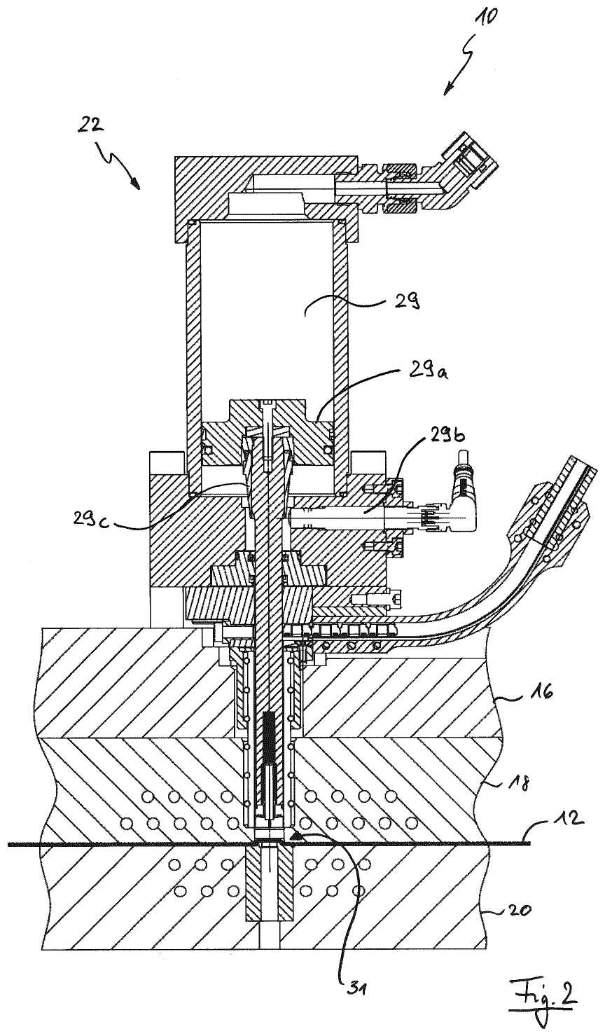

The setting die 28 is moved by supplying a hydraulic fluid to a hydraulic chamber 29 (see FIG. 2). When the chamber 29 fills with the fluid, it presses a piston 29a, to which the setting die 28 is fastened, downwards. The movement S of the setting die 28 along a setting axis A can in this respect be monitored by a sensor 29b that interacts with a conical sleeve 29c arranged at the setting die 28 (see FIG. 3).

During the reshaping and setting process, the workpiece 12 rests on a die 30. The die 30 is releasably attached to the molding jaw 20 to be able to be easily replaced, if necessary.

In FIG. 2, it can be seen that the molding jaws 18, 20 have pressed the workpiece 12 against the die 30 by closing the tool halves 14 such that a local elevated portion 31 has formed. Subsequently or already during the closing process of the tool halves 14, the functional element 24 is advanced by means of the setting die 28.

The closing of the tool halves 14 takes place by a drive that can be actuated separately from the hydraulic drive of the setting device 22. As a result, the time sequence of the closing of the tool halves 14 (and thus also the reshaping of the workpiece 12) and of the setting of the element 24 can be adapted to the respective prevailing conditions.

In FIG. 3, the apparatus 10 can be seen in a state in which the tool halves 14 are still closed. The functional element 24 was fastened at the setting point, which is formed by the elevated portion 31, at the workpiece 12 by the setting die 28. In this respect, the element 24 has punched a slug 32 out of the workpiece 12. The element 24 is consequently a self-punching element. However, the concept according to the invention can also be used for the fastening of elements that are inserted into prefabricated holes.

Due to the shaping of die 30, material of the workpiece 12 was pressed into a receiving space of the element 24, whereby an undercut securing the element 24 to the workpiece 12 was produced.

The slug 32 cut out by the self-punching functional elements 24 is ejected from the element 24 by means of an ejection die 34 movable coaxially to the setting die 28. Said ejection die 34 penetrates through a central opening of the functional element 24, which is configured as a nut element, and presses the slug 32 downwards out of the element 24 so that said slug can be discharged through passages 36, 38 in the die 30 or in the molding jaw 20.

In the apparatus 10 described with reference to FIGS. 1 to 3, the movements U of the tool halves 14 and the movement S of the setting die 28 are aligned in parallel. In the case of more complex geometries of the workpiece 12, which can, for example, only be produced by a reshaping by means of the tool halves 14, it is, however, also possible to provide different directions of movement U, A. For example, the setting device 22 can be configured and set up such that the movement of the setting die 28 takes place slightly obliquely to the directions of movement U of the tool halves 14 during the closing process. This is indicated in FIG. 3 by the alternative setting axes A′ and A″ shown by way of example. Thus, elements 24 can be fastened at setting points in which the workpiece 12 extends obliquely to the direction of movement of the tool halves 14. The inclination of the oblique setting axis A′, A″ is preferably selected so that it is perpendicular to the extent of the workpiece 12 at the setting point.

FIG. 4 shows an enlarged section of FIG. 3 so that the element 24 fastened to the workpiece 12 can be better recognized. Furthermore, it can be seen more clearly how the ejection die 34 drives the slug 32 out of the element 24.

Fluid passages 40 can furthermore be recognized that extend through the molding jaws 18, 20. By means of a suitably temperature-controlled fluid that is conducted through the fluid passages 40, the molding jaws 18, 20 can be heated or cooled locally as required. This can be advantageous, for example, to keep the workpiece 12 in a region around the setting point in a temperature window suitable for the setting process.

In FIG. 4, it can be seen that the arrangement and number of passages 40 in the molding jaw 40 is different from that in the molding jaw 18. In the present application, this asymmetrical design is advantageous. The geometry (e.g. diameter, shape) and/or the arrangement and/or the number of passages 40 can generally be freely selected. It is also conceivable to provide other apparatuses for the thermal conditioning (conditioning apparatus) of the molding jaws 18, 20 or of the workpiece 12 instead of a fluid heating/cooling. For example, electrically operable heating wires can—additionally or alternatively—be provided.

The conditioning device can be designed as controllable to be able to satisfy the respective present requirements. The conditioning device is preferably designed as flexible so that different types of temperature profiles can be produced by means of the conditioning device without a more complex redesign. For example, it can be provided that not all the passages 40 need to be supplied with a heating or cooling fluid and/or that certain heating wires can be selectively energized in order to thermally condition the molding jaws 18, 20, and thus ultimately the workpiece 12, locally as required. The thermal conditioning device and a control device associated therewith are in particular designed such that the thermal influence is variable in space and/or in time. For example, it can even be adapted as required during a setting process.

It is generally also possible to provide a thermal conditioning device (for heating and/or cooling) at the setting device 22 to act on the setting device 22 itself and/or the molding jaw 18. It would also be conceivable to influence the temperature of the functional element 24.

The apparatus 10 can have at least one, preferably a plurality of sensors (not shown), by means of which process parameters are detected to be able to estimate the quality of the connection produced between the functional element 24 and the workpiece 12. The acquired data can be compared with stored threshold values so that warning signals can be output if these threshold values are exceeded or fallen below. The acquired and/or determined data can be linked to data of the workpiece 12 (for example, a unique workpiece identification) for documentation purposes to be able to provide complete proof of quality.

Such sensors can be associated with the setting device 22, for example, to detect the pressing force (setting force) acting on the respective functional element 24 during the setting process. The setting movement S itself can also be monitored, for example by measuring the distance traveled, the speed and/or the acceleration as a function of time.

A pressing force acting between the tool halves 14 and/or a characteristic parameter of the reshaping movement (for example, the distance traveled, the speed and/or the acceleration) can, for example, be detected by alternative or additional sensors. A detection of at least one characteristic parameter of the first and/or the second tool half, such as a temperature of the tool halves 14, is also conceivable. If a plurality of temperature sensors are provided, a respective temperature profile of the tool halves 14 (e.g. in a region around the setting point) can also be determined. By comparing the determined ACTUAL profile with a targeted DESIRED profile, an unwanted deviation can be determined and the thermal influence can be adapted accordingly.

The apparatus 10 is characterized by two basic measures by means of which a reshaping and setting process can be optimized. On the one hand, the setting device 22 is operated independently of the tool halves 14 responsible for the reshaping so that the respective optimal setting time can be selected in each case, for example if the workpiece 12 has already cooled down somewhat and is in a suitable temperature window.

On the other hand, a thermal conditioning of the tool halves 14, in particular of the molding jaw at 18, 20, is provided, whereby heat can be supplied to or led off from the workpiece 12 as required, among other things, in order to bring said workpiece into a temperature window suitable for the setting of the functional element 24 or to keep said workpiece there. This measure can be supplemented by a thermal conditioning device associated with the setting device 22.

Even though these two basic measures are implemented in the apparatus 10, it is understood that they can also be used independently of one another.

Deviating from the embodiment example shown, it can also be provided that the setting movement S is reversed, i.e. comprises a movement from the bottom to the top. The direction of movement U of the jaws 18, 20 does not necessarily have to take place in the vertical either. Other angular positions are conceivable. The same applies to the setting movement S.
10 apparatus
12 workpiece
14 tool half
16 base body
18,20 molding jaw
22 setting device
24 functional elements
26 hose
28 setting die
29 hydraulic chamber
29a piston
29b sensor
29c sleeve
30 die
31 elevated portion
32 slug
34 ejection die
36, 38 passage
40 fluid passage
A, A′, A″ setting axis
U direction of movement of the molding jaws 18, 20
S setting movement

1. An apparatus for processing a workpiece, said apparatus comprising at least one pressing device having a first tool half and a second tool half that can be moved towards one another in a pressing movement, in particular for reshaping and/or for press hardening the workpiece, and
at least one setting device for fastening at least one functional element in a setting movement at a setting point to the workpiece,
wherein the setting device is arranged at the first tool half or the second tool half, and
wherein the first and/or the second tool half has/have a conditioning device with which the first tool half and/or the second tool half can be thermally influenced.

2. The apparatus according to claim 1, wherein the first and/or the second tool half can be selectively thermally influenced.

3. The apparatus according to claim 1, wherein the first tool half and the second tool half can be moved towards one another for reshaping and/or for press hardening the workpiece.

4. The apparatus according to claim 1, wherein the conditioning device is configured and set up such that the first and/or the second tool half can be selectively thermally influenced at and/or in a region adjacent to the setting point.

5. The apparatus according to claim 1, wherein the conditioning device is configured and set up such that a desired temperature profile can be produced in the first and/or the second tool half.

6. The apparatus according to claim 1,
wherein the setting device has a conditioning device with which the setting device and/or the workpiece and/or the functional element can be thermally influenced.

7. The apparatus according to claim 6,
wherein the setting device and/or the workpiece and/or the functional element can be selectively influenced.

8. The apparatus according to claim 1,
wherein the conditioning device comprises a heating device and/or a cooling device.

9. The apparatus according to claim 1, wherein the conditioning device can be operated electrically and/or with a fluid.

10. The apparatus according to claim 1, wherein the conditioning device is configured and set up such that the thermal influence is variable in time and/or in space.

11. The apparatus according to claim 1,
wherein a control device is provided with which the conditioning device can be selectively controlled.

12. The apparatus according to claim 1,
wherein the setting device comprises at least one sensor device with which a setting force acting on the functional element and/or at least one characteristic parameter of the setting movement can be detected.

13. The apparatus according to claim 1, wherein the first and/or the second tool half comprises/comprise at least one sensor device with which a pressing force acting between the tool halves and/or a characteristic parameter of the pressing movement and/or a characteristic parameter of the first and/or the second tool half can be detected.

14. The apparatus according to claim 1,
wherein the apparatus is configured and set up such that a self-punching functional element can be fastened to the workpiece.

15. A method of processing a workpiece, wherein a first tool half and a second tool half of a pressing device are moved towards one another in a pressing movement, and
wherein a functional element is pressed against the workpiece at a setting point by means of a setting device in a setting movement in order to fasten said functional element to said workpiece,
wherein the first and/or the second tool half is/are thermally influenced by means of a conditioning device.

16. The method according to claim 15, wherein an apparatus for processing the workpiece is used, said apparatus comprising
at least one said pressing device having the first tool half and the second tool, and
at least one said setting device for fastening at least one said functional element in a setting movement at the setting point to the workpiece,
wherein the setting device is arranged at the first tool half or the second tool half, and
wherein the first and/or the second tool half has/have the conditioning device with which the first tool half and/or the second tool half can be thermally influenced.

17. The method according to claim 15,
wherein the setting device and/or the workpiece and/or the functional element is/are thermally influenced by means of a conditioning device associated with the setting device.

18. The method according to claim 15,
wherein the thermal influence is varied in space and/or in time.

19. The method according to claim 15, wherein a setting force acting on the functional element and/or at least one characteristic parameter of the setting movement is/are detected by means of a sensor device.

20. The method according to claim 15, wherein a pressing force acting between the tool halves and/or a characteristic parameter of the pressing movement and/or a characteristic parameter of the first and/or the second tool half is/are detected by means of a sensor device.
